(19) United States
(12) Patent Application Publication
(10) Pub. No.: US 2005/0282029 A1
(43) Pub. Date: Dec. 22, 2005

(54) Polymerizable composition and articles therefrom

(75) Inventors: Steven J. Keipert, Somerset, WI (US); Ernest L. Thurber, Woodbury, MN (US); Don H. Kincaid, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/871,451

(22) Filed: Jun. 18, 2004

(51) Int. Cl. B32B 27/30; B32B 27/28; C08L 33/00; C08F 2/46

(52) U.S. Cl. 428/523; 525/55; 525/540; 522/6

(57) ABSTRACT

An isotropic polymerizable composition comprising: a polyfunctional aziridine, an acidic free-radically polymerizable monomer, and an oligomer having at least two pendant free-radically polymerizable groups, wherein homopolymerization of the oligomer results in a polymer having a glass transition temperature of less than 50 degrees Celsius. The composition is useful for treating a backing.

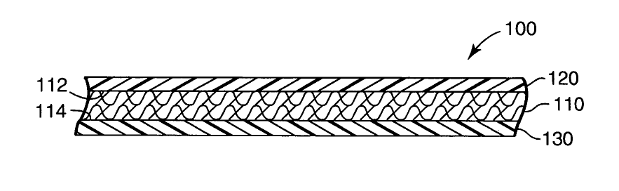

### BACKGROUND

In general, coated abrasive articles have abrasive particles secured to a backing. More typically, coated abrasive articles comprise a backing having two major opposed surfaces and an abrasive layer secured to one of the major surfaces. The abrasive layer is typically comprised of abrasive particles and a binder, wherein the binder serves to secure the abrasive particles to the backing.

One common type of coated abrasive article has an abrasive layer which comprises a make layer, a size layer, and abrasive particles. In making such a coated abrasive article, a make layer comprising a first binder precursor is applied to a major surface of the backing. Abrasive particles are then at least partially embedded into the make layer (e.g., by electrostatic coating), and the first binder precursor is cured (i.e., crosslinked) to secure the particles to the make layer. A size layer comprising a second binder precursor is then applied over the make layer and abrasive particles, followed by curing of the binder precursors.

Another common type of coated abrasive article comprises an abrasive layer secured to a major surface of a backing, wherein the abrasive layer is provided by applying a slurry comprised of binder precursor and abrasive particles onto a major surface of a backing, and then curing the binder precursor.

In another aspect, coated abrasive articles may further comprise a supersize layer covering the abrasive layer. The supersize layer typically includes grinding aids and/or anti-loading materials.

Optionally, backings used in coated abrasive articles may be treated with one or more applied coatings. Examples of typical backing treatments are a backsize (i.e., a coating on the major surface of the backing opposite the abrasive layer), a presize (i.e., a coating on the backing disposed between the abrasive layer and the backing), and/or a saturant that saturates the backing. A subsize is similar to a saturant, except that it is applied to a previously treated backing.

However, depending on the particular choice of abrasive layer and backing (treated or untreated), the abrasive layer may partially separate from the backing during abrading resulting in the release of abrasive particles. This phenomenon is known in the abrasive art as “shelling”. In most cases, shelling is undesirable because it results in a loss of performance.

In one approach, a tie layer disposed between the backing and the abrasive layer has been used to address the problem of shelling in some coated abrasive articles.

Yet, despite such advances, there remains a continuing need for new materials and methods that can reduce the problem of shelling in coated abrasive articles.

### SUMMARY

In one aspect, the present invention provides an isotropic polymerizable composition comprising a polyfunctional aziridine, an acidic free-radically polymerizable monomer, and an oligomer having at least two pendant free-radically polymerizable groups, wherein homopolymerization of the oligomer results in a polymer having a glass transition temperature of less than 50 degrees Celsius.

In another aspect, the present invention provides a method of making a product comprising:
providing an isotropic polymerizable composition comprising a polyfunctional aziridine, an acidic free-radically polymerizable monomer, and an oligomer having at least two pendant free-radically polymerizable groups, wherein homopolymerization of the oligomer results in a polymer having a glass transition temperature of less than 50 degrees Celsius; and
at least partially polymerizing the isotropic polymerizable composition.

In yet another aspect, the present invention provides a treated backing comprising a backing having at least one treatment secured thereto selected from the group consisting of a presize, a backsize, a subsize, and a saturant, wherein the treatment is preparable by at least partially polymerizing an isotropic polymerizable composition comprising a polyfunctional aziridine, an acidic free-radically polymerizable monomer, and an oligomer having at least two pendant free-radically polymerizable groups, and wherein homopolymerization of the oligomer results in a polymer having a glass transition temperature of less than 50 degrees Celsius.

In yet another aspect, the present invention provides a method of making a treated backing comprising:
providing a backing;
contacting at least a portion of the backing with an isotropic polymerizable composition comprising a polyfunctional aziridine, an acidic free-radically polymerizable monomer, and an oligomer having at least two pendant free-radically polymerizable groups, and wherein homopolymerization of the oligomer results in a polymer having a glass transition temperature of less than 50 degrees Celsius; and
at least partially polymerizing the isotropic polymerizable composition.

In some embodiments of the various aspects given above, the isotropic polymerizable composition further comprises one or more curatives.

Treated backings according to the present invention are useful, for example, in the manufacture of coated abrasive articles.

As used herein, the term “(meth)acryl” includes both “acryl” and “methacryl”.

### BRIEF DESCRIPTION OF THE DRAWING

The drawing is a cross-sectional view of an exemplary treated backing.

### DETAILED DESCRIPTION

The isotropic polymerizable composition comprises a polyfunctional aziridine, an acidic free-radically polymerizable monomer, and an oligomer having at least two pendant free-radically polymerizable groups, wherein homopolymerization of the oligomer results in a polymer having a glass transition temperature of less than 50 degrees Celsius.

As used herein, the term “polyfunctional aziridine” refers to a species having a plurality of aziridinyl groups. Suitable polyfunctional aziridines include, for example, those disclosed in U.S. Pat. No. 3,225,013 (Fram); U.S. Pat. No. 4,769,617 (Canty); and U.S. Pat. No. 5,534,391 (Wang), the disclosures of which are incorporated herein by reference. Specific examples include trimethylolpropane tris[3-aziridinyl propionate]; trimethylolpropane tris[3-(2-methylaziridinyl)propionate]; trimethylolpropane tris[2-aziridinylbutyrate]; tris(1-aziridinyl)phosphine oxide; tris(2-methyl-1-aziridinyl)phosphine oxide; pentaerythritol tris[3-(1-aziridinyl)propionate]; and pentaerythritol tetrakis[3-(1-aziridinyl)propionate]. Combinations of more than one polyfunctional aziridine may also be used.

Commercially available polyfunctional aziridines include those available under the trade designations “XAMA-2” (believed to be trimethylolpropane tris[3-(2-methylaziridinyl)propanoate]) and “XAMA-7” (believed to be pentaerythritol tris(beta-(N-aziridinyl)propionate)) from EIT, Inc. Corporation, Lake Wylie, S.C.; “HYDROFLEX XR2990” (believed to be trimethylolpropane tris[3-(2-methylaziridinyl)propanoate]) from H.B. Fuller Co., Vadnais Heights, Minn.; and “NEOCRYL CX-100” (believed to be trimethylolpropane tris[3-(2-methylaziridinyl)-propanoate]) from Zeneca Resins, Wilmington, Mass.

The amount of polyfunctional aziridine incorporated into the isotropic polymerizable composition is generally in a range of from at least 0.5, 1, or 2 percent by weight up to and including 4, 6, 8, or even 10 percent by weight, or more, based on the total weight of polyfunctional aziridine, acidic free-radically polymerizable monomer, and oligomer having at least two pendant free-radically polymerizable groups.

The acidic free-radically polymerizable monomer has both an acidic group and a group (e.g., a (meth)acryl group) that is free-radically polymerizable. The acidic group may be, for example, carbon-, sulfur-, or phosphorus-based, and may be the free acid or in a partially or fully neutralized state. The acidic free-radically polymerizable monomer may have more than one acidic groups and/or free-radically polymerizable groups.

Useful carbon-based acidic free-radically polymerizable monomers include, for example, (meth)acrylic acid, maleic acid, monoalkyl esters of maleic acid, fumaric acid, monoalkyl esters of fumaric acid, itaconic acid, isocrotonic acid, crotonic acid, citraconic acid, and beta-carboxyethyl acrylate.

Useful sulfur-based acidic free-radically polymerizable monomers include, for example, 2-sulfoethyl methacrylate, styrene sulfonic acid, and 2-acrylamido-2-methylpropanesulfonic acid.

Useful phosphorus-based acidic free-radically polymerizable monomers include, for example, vinyl phosphonic acid.

Acidic, free radically polymerizable monomers are commercially available, for example, under the trade designations “PHOTOMER 4173” from Cognis Corp., Cincinnati, Ohio, and “CN118”, “CD9050”, “CD9051” and “CD9052” all from Sartomer Co., Exton Pa.

The amount of acidic free-radically polymerizable monomer incorporated into the isotropic polymerizable composition is generally in a range of from at least 1, or 2 percent by weight up to and including 5, 10, 20, 30, or even 45 percent by weight, or more, based on the total weight of polyfunctional aziridine, acidic free-radically polymerizable monomer, and oligomer having at least two pendant free-radically polymerizable groups.

The oligomer having at least two pendant free-radically polymerizable groups is selected such that free-radical homopolymerization of the oligomer (e.g., by photo- or thermal initiation) results in a polymer having a glass transition temperature at or below 50 degrees Celsius (° C.). As used herein, the term “oligomer” refers to molecule composed of a small number of linked monomer units. Oligomers generally have less than one hundred monomer units and more typically less than thirty.

Useful oligomers having at least two pendant free-radically polymerizable groups include, for example, aliphatic and aromatic urethane (meth)acrylate oligomers, polybutadiene (meth)acrylate oligomer, acrylic (meth)acrylate oligomers, polyether (meth)acrylate oligomers, aliphatic and aromatic polyester (meth)acrylate oligomers, epoxy (meth)acrylate oligomers, and combinations thereof.

Methods for making such oligomers are well known in the art, and many useful free-radically polymerizable oligomers are commercially available. Examples include aliphatic and aromatic urethane (meth)acrylate oligomers such as those available from UCB Chemicals Corp., Smyrna, Ga., under the trade designations “EBECRYL 270”, “EBECRYL 8804”, “EBECRYL 8807”, “EBECRYL 4827”, “EBECRYL 6700”, “EBECRYL 5129”, or “EBECRYL 8402” and those available from Sartomer Co., Exton, Pa., under the trade designations “CN 1963”, “CN 934”, “CN 953B70”, “CN 984”, “CN 962”, “CN 964”, “CN 965”, “CN 972”, “CN 978”; polyester (meth)acrylate oligomers such as those available from UCB Chemicals Corp. under the trade designations “EBECRYL 80”, “EBECRYL 81”, “EBECRYL 657”, “EBECRYL 810”, “EBECRYL 450”, “EBECRYL 870”, or “EBECRYL 2870” and that available from Sartomer Co. under the trade designation “CN 292”; polyether (meth)acrylate oligomers such as those available from Sartomer Co. under the trade designations “CN 501”, “CN 502”, “CN 550”, “CN 551”; acrylic oligomers such as those available from Sartomer Co. under the trade designations “CN 816”, “CN 817”, “CN 818”; epoxy (meth)acrylate oligomers such as that available from Sartomer Co. under the trade designation, “CN119”, and “CN121”; and polybutadiene (meth)acrylate oligomers such as that available from Sartomer Co. under the trade designation “CN 301”.

The amount of oligomer incorporated into the isotropic polymerizable composition is generally in a range of from at least 30, 35, 40, or 45 percent by weight up to and including 50, 60, 70, 80, 90, or even 95 percent by weight, or more, based on the total weight of polyfunctional aziridine, acidic free-radically polymerizable monomer, and oligomer having at least two pendant free-radically polymerizable groups.

The isotropic polymerizable composition may, optionally, further comprise one or more curatives that are capable of at least partially polymerizing the isotropic polymerizable composition. Useful curatives include free-radical initiators such as, for example, photoinitiators and/or thermal initiators for free-radical polymerization. Blends of photo- and/or thermal initiators may be used.

Useful photoinitiators include those known as useful for photocuring free-radically polyfunctional acrylates. Exemplary photoinitiators include benzoin and its derivatives such as alpha-methylbenzoin; alpha-phenylbenzoin; alpha-allylbenzoin; alpha-benzylbenzoin; benzoin ethers such as benzil dimethyl ketal (e.g., as commercially available under the trade designation “IRGACURE 651” from Ciba Specialty Chemicals, Tarrytown, N.Y.), benzoin methyl ether, benzoin ethyl ether, benzoin n-butyl ether; acetophenone and its derivatives such as 2-hydroxy-2-methyl-1-phenyl-1-propanone (e.g., as commercially available under the trade designation “DAROCUR 1173” from Ciba Specialty Chemicals) and 1-hydroxycyclohexyl phenyl ketone (e.g., as commercially available under the trade designation “IRGACURE 184” from Ciba Specialty Chemicals); 2-methyl-1-[4-(methylthio)phenyl]-2-(4-morpholinyl)-1-propanone (e.g., as commercially available under the trade designation “IRGACURE 907” from Ciba Specialty Chemicals); 2-benzyl-2-(dimethylamino)-1-[4-(4-morpholinyl)phenyl]-1-butanone (e.g., as commercially available under the trade designation “IRGACURE 369” from Ciba Specialty Chemicals).

Other useful photoinitiators include, for example, pivaloin ethyl ether, anisoin ethyl ether, anthraquinones (e.g., anthraquinone, 2-ethylanthraquinone, 1-chloroanthraquinone, 1,4-dimethylanthraquinone, 1-methoxyanthraquinone, or benzanthraquinone), halomethyltriazines, benzophenone and its derivatives, iodonium salts and sulfonium salts, titanium complexes such as bis(eta₅-2,4-cyclopentadien-1-yl)-bis[2,6-difluoro-3-(1H-pyrrol-1-yl)phenyl]titanium (e.g., as commercially available under the trade designation “CGI 784DC” from Ciba Specialty Chemicals); halomethyl-nitrobenzenes (e.g., 4-bromomethylnitrobenzene), mono- and bis-acylphosphines (e.g., as commercially available from Ciba Specialty Chemicals under the trade designations “IRGACURE 1700”, “IRGACURE 1800”, “IRGACURE 1850”, and “DAROCUR 4265”).

One or more spectral sensitizers (e.g., dyes) may be added to the isotropic polymerizable composition in combination with the optional photoinitiator, for example, in order to increase sensitivity of the photoinitiator to a specific source of actinic radiation.

Examples of suitable thermal free-radical polymerization initiators include peroxides such as benzoyl peroxide, dibenzoyl peroxide, dilauryl peroxide, cyclohexane peroxide, methyl ethyl ketone peroxide; hydroperoxides such as tert-butyl hydroperoxide and cumene hydroperoxide; dicyclohexyl peroxydicarbonate; 2,2′-azobis(isobutyronitrile); and t-butyl perbenzoate. Examples of commercially available thermal free-radical polymerization initiators include initiators available from E. I. du Pont de Nemours and Co., Wilmington, Del., under the trade designation “VAZO” (e.g., “VAZO 64” and “VAZO 52”) and from Elf Atochem North America, Philadelphia, Pa., under the trade designation “LUCIDOL 70”.

If present, the curative is typically used in an amount effective to facilitate polymerization, for example, in an amount in a range of from about 0.01 percent by weight up to about 10 percent by weight, based on the total amount of isotropic polymerizable composition, although amounts outside of these ranges may also be useful.

In addition to other components, the isotropic polymerizable composition of the present invention may contain optional additives, for example, to modify performance and/or appearance. Exemplary additives include, fillers, solvents, plasticizers, wetting agents, surfactants, pigments, coupling agents, fragrances, fibers, lubricants, thixotropic materials, antistatic agents, suspending agents, pigments, and dyes.

Reactive diluents may also be added to the isotropic polymerizable composition, for example, to adjust viscosity and/or physical properties of the cured composition. Examples of suitable reactive diluents include diluents mono and polyfunctional (meth)acrylate monomers (e.g., ethylene glycol di(meth)acrylate, hexanediol di(meth)acrylate, triethylene glycol di(meth)acrylate, trimethylolpropane tri(meth)acrylate, tripropylene glycol di(meth)acrylate), vinyl ethers (e.g., butyl vinyl ether), vinyl esters (e.g., vinyl acetate), and styrenic monomers (e.g., styrene).

Typically, it is only necessary to combine the components under conditions wherein sufficient mixing occurs in order to prepare an isotropic polymerizable composition. In cases wherein the components of the composition are mutually soluble, the composition may be homogeneous throughout its entirety. To facilitate mixing agitation and/or stirring may be used. In instances, of higher viscosity, the mixture may be heated to reduce its viscosity.

The isotropic polymerizable composition may be at least partially polymerized by a number of well-known techniques such as, for example, by exposure electron beam radiation, actinic radiation (i.e., ultraviolet and/or visible electromagnetic radiation), and thermal energy. If actinic radiation is used, at least one photoinitiator is typically present in the isotropic polymerizable composition. If thermal energy is used, at least one thermal initiator is typically present in the isotropic polymerizable composition. The polymerization may be carried out in air or in an inert atmosphere such as, for example, nitrogen or argon.

Isotropic polymerizable compositions according to the present invention are typically useful as treatments for backing materials useful in the manufacture of coated abrasive articles.

Referring now to the drawing, exemplary treated backing 100 has backing 110 having first and second opposed major surfaces 112 and 114, respectively. Optional presize 120 is disposed on first major surface 112. Optional backsize 130 is disposed on second major surface 114. If backing 110 is porous, optional saturant (not shown) and/or optional subsize (not shown) may permeate backing 110.

Suitable backings include those known in the art for making coated abrasive articles. Typically, the backing has two opposed major surfaces. The thickness of the backing generally ranges from about 0.02 to about 5 millimeters, desirably from about 0.05 to about 2.5 millimeters, and more desirably from about 0.1 to about 0.4 millimeter, although thicknesses outside of these ranges may also be useful.

The backing may be flexible or rigid, and may be made of any number of various materials including those conventionally used as backings in the manufacture of coated abrasives. Examples include paper, cloth, film, polymeric foam, vulcanized fiber, woven and nonwoven materials, combinations of two or more of these materials. The backing may also be a laminate of two materials (e.g., paper/film, cloth/paper, film/cloth).

Exemplary flexible backings include polymeric film (including primed films) such as polyolefin film (e.g., polypropylene including biaxially oriented polypropylene, polyester film, polyamide film, cellulose ester film), metal foil, mesh, foam (e.g., natural sponge material or polyurethane foam), cloth (e.g., cloth made from fibers or yarns comprising polyester, nylon, silk, cotton, and/or rayon), paper, vulcanized paper, vulcanized fiber, nonwoven materials, and combinations thereof. Cloth backings may be woven or stitch bonded.

The backing may be a fibrous reinforced thermoplastic such as described, for example, as described, for example, in U.S. Pat. No. 5,417,726 (Stout et al.), or an endless spliceless belt, for example, as described, for example, in U.S. Pat. No. 5,573,619 (Benedict et al.), the disclosures of which are incorporated herein by reference. Likewise, the backing may be a polymeric substrate having hooking stems projecting therefrom such as that described, for example, in U.S. Pat. No. 5,505,747 (Chesley et al.), the disclosure of which is incorporated herein by reference. Similarly, the backing may be a loop fabric such as that described, for example, in U.S. Pat. No. 5,565,011 (Follett et al.), the disclosure of which is incorporated herein by reference.

Exemplary rigid backings include metal plates, and ceramic plates. Another example of a suitable rigid backing is described, for example, in U.S. Pat. No. 5,417,726 (Stout et al.), the disclosure of which is incorporated herein by reference.

The application of the isotropic polymerizable composition to the backing can be performed in a variety of ways including, for example, such techniques as brushing, spraying, roll coating, curtain coating, gravure coating, and knife coating. Organic solvent may be added to the isotropic polymerizable composition to facilitate the specific coating technique used. The coated backing may then be processed for a time at a temperature sufficient to dry (if organic solvent is present) and at least partially polymerize the coating thereby securing it to the backing.

Once applied to the backing, the isotropic polymerizable composition is typically at least partially polymerized, for example, by one or more methods described hereinabove resulting in a treated backing, which may be used, for example, in the manufacture of coated abrasive articles.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

The following abbreviations are used throughout the Examples,

TABLE OF ABBREVIATIONS

| | |
|---|---|
| AFR1 | modified epoxy acrylate, commercially available under the trade designation |
| | “CN118” from Sartomer Co., Exton, Pennsylvania |
| AFR2 | monofunctional acid ester acrylate, commercially available under the trade |
| | designation “CD9050” from Sartomer Co. |
| AFR3 | trifunctional acid ester acrylate, commercially available under the trade |
| | designation “CD9052” from Sartomer Co. |
| AFR4 | acidic aromatic acrylate oligomer, commercially available under the trade |
| | designation “PHOTOMER 4173” from Cognis Corp., Cincinnati, Ohio |
| AZ1 | polyfunctional aziridine commercially available under the trade designation |
| | from “HYDROFLEX XR-2990” from H.B. Fuller Co. |
| BR1 | acrylated aliphatic urethane, commercially available under the trade designation |
| | “EBECRYL 8402” from UCB Group |
| BR2 | acrylated polyester, obtained under the trade designation “EBECRYL 810” |
| | from UCB Group |
| C1 | a 100% polyester jean fabric made from open-end spun yarns weighing 175 |
| | grams/m², commercially available from Milliken and Co. |
| C2 | a dyed and stretched, 100% cotton drill fabric from open end spun yarns |
| | weighing 224 grams/m², commercially available from Milliken and Co., |
| | Spartanburg, South Carolina, |
| pbw | parts by weight |
| PI1 | 2-benzyl-2-(dimethylamino)-1-[4-(4-morpholinyl)phenyl]-1-butanone, |
| | commercially available under the trade designation “IRGACURE 369” from |
| | Ciba Specialty Chemicals, Hawthorne, New York |
| PI2 | 2,2-dimethoxy-2-phenylacetophenone, commercially available under the trade |
| | designation “IRGACURE 651” from Ciba Specialty Chemicals |
| RPR1 | resole phenolic (a phenol-formaldehyde resin, having phenol to formaldehyde |
| | ratio of 1.5-2.1/1, catalyzed with 2.5 percent potassium hydroxide |

General Method for Preparation of a Polymerizable Composition

Acidic, free-radically polymerizable monomer is added to the oligomer having at least two pendant free-radically polymerizable groups, followed by photoinitiator, at 20° C. The mixture is stirred until homogeneous using a mechanical stirrer, then heated at 50° C. in an oven for 2 hours. After removing the mixture from the oven, polyfunctional aziridine is added and the stirring continued for 10 minutes until dissolved.

General Procedure for Curing a Polymerizable Composition

The polymerizable composition is coated on a 25 mm×75 mm glass slide with a one-inch (2.5-cm) wide hand-held knife, commercially available from the Paul N. Gardner Company, Pompano Beach, Fla. The knife gap was set at 10 mils (254 micrometers). The resultant composition is irradiated by passing once through a UV processor obtained under the trade designation “UV PROCESSOR”, obtained from Fusion UV Systems, Gaithersburg, Md., using a “FUSION D” bulb at 761 Watts/inch² (118 W/cm²) and 16.4 feet/minute (5 m/min), then thermally cured at 120° C. for about 10 minutes.

General Procedure for Treating a Cloth Backing

Freshly prepared warm polymerizable composition precursor was applied to a cloth backing using a 4-inch (10-cm) wide hand-held coating knife commercially available from the Paul N. Gardner Company. The knife gap was set at 225 micrometers. The resultant coating on the backing was then irradiated by passing once through a UV processor obtained under the trade designation “UV PROCESSOR”, obtained from Fusion UV Systems, Gaithersburg, Md., using a “FUSION D” bulb at 761 Watts/inch² (118 W/cm²) and 16.4 feet/minute (5 m/min), then thermally cured at 120° C. for about 10 minutes.

### Examples 1-21

Polymerizable compositions were prepared according to the General Method for Preparation of a Polymerizable Composition in amounts as indicated in Table 1. The polymerizable compositions were then cured according to the General Procedure for Curing a Polymerizable Composition.

TABLE 1

| | Polymerizable Composition Precursor Components | | | |
|---|---|---|---|---|
| | | Acidic | | |
| | Oligomer / | monomer / | Curative / | |
| Polymerizable | amount, | amount, | amount, | Amount of |
| Composition | (pbw) | (pbw) | (pbw) | AZ1, (pbw) |
| 1 | BR1 / 90 | AFR3 / 10 | PI1 | 1 |
| 2 | BR1 / 90 | AFR3 / 10 | PI1 | 2 |
| 3 | BR1 / 90 | AFR3 / 10 | PI1 | 5 |
| 4 | BR2 / 89 | AFR4 / 5 | PI2 | 5 |
| 5 | BR2 / 74 | AFR1 / 20 | PI2 | 5 |
| 6 | BR2 / 79 | AFR3 / 10, | PI2 | 5 |
| | | AFR4 / 5 | | |
| 7 | BR1 / 86 | AFR4 / 8 | PI2 | 5 |
| 8 | BR1 / 91 | AFR4 / 5 | PI2 | 3 |
| 9 | BR2 / 86 | AFR4 / 8 | PI2 | 5 |
| 10 | BR2 / 92 | AFR4 / 2 | PI2 | 5 |
| 11 | BR1 / 83.5 | AFR3 / 12.5 | PI2 | 3 |
| 12 | BR1 / 89 | AFR3 / 5 | PI2 | 5 |
| 13 | BR2 / 83.5 | AFR3 / 12.5 | PI2 | 3 |
| 14 | BR2 / 89 | AFR3 / 5 | PI2 | 5 |
| 15 | BR1 / 78 | AFR2 / 20 | PI2 | 1 |
| 16 | BR1 / 74 | AFR2 / 20 | PI2 | 5 |
| 17 | BR2 / 89 | AFR2 / 5 | PI2 | 5 |
| 18 | BR2 / 86 | AFR4 / 8 | PI2 | 5 |
| 19 | BR1 / 92 | AFR4 / 2 | PI2 | 5 |
| 20 | BR1 / 90 | AFR4 / 8 | PI2 | 1 |
| 21 | BR2 / 92 | AFR4 / 2 | PI2 | 5 |

### Example 22

The polymerizable composition of Example 8 was applied as a saturant onto cloth backing C1 according to the General Procedure for Treating a Cloth Backing.

### Example 23

The polymerizable composition of Example 8 was applied as a presize onto the treated cloth backing of Example 23 according to the General Procedure for Treating a Cloth Backing.

### Example 24

The polymerizable composition of Example 8 was applied as a saturant onto cloth backing C2 according to the General Procedure for Treating a Cloth Backing.

### Example 26

The polymerizable composition of Example 8 was applied as a presize onto the treated cloth backing of Example 25 according to the General Procedure for Treating a Cloth Backing.

Various modifications and alterations of this invention may be made by those skilled in the art without departing from the scope and spirit of this invention, and it should be understood that this invention is not to be unduly limited to the illustrative embodiments set forth herein.

1. An isotropic polymerizable composition comprising:
a polyfunctional aziridine,
an acidic free-radically polymerizable monomer, and
an oligomer having at least two pendant free-radically polymerizable groups, wherein homopolymerization of the oligomer results in a polymer having a glass transition temperature of less than 50 degrees Celsius.

2. An isotropic polymerizable composition according to claim 1, further comprising a curative.

3. An isotropic polymerizable composition according to claim 2, wherein the curative comprises a free-radical photoinitiator.

4. An isotropic polymerizable composition according to claim 2, wherein the curative comprises a free-radical thermal initiator.

5. An isotropic polymerizable composition according to claim 1, wherein based on the total weight of polyfunctional aziridine, acidic free-radically polymerizable monomer, and oligomer having at least two pendant free-radically polymerizable groups, the amount of polyfunctional aziridine is in a range of from 0.5 to 10 percent based on the total weight of weight polyfunctional aziridine, and wherein the amount of acidic free-radically polymerizable monomer is in a range of from 1 to 45 percent.

6. An isotropic polymerizable composition according to claim 1, wherein based on the total weight of polyfunctional aziridine, acidic free-radically polymerizable monomer, and oligomer having at least two pendant free-radically polymerizable groups, the amount of polyfunctional aziridine is in a range of from 2 to 4 percent based on the total weight of weight polyfunctional aziridine, and wherein the amount of acidic free-radically polymerizable monomer is in a range of from 2 to 20 percent.

7. An isotropic polymerizable composition according to claim 1, wherein the polyfunctional aziridine is selected from the group consisting of trimethylolpropane tris[3-aziridinyl propionate], trimethylolpropane tris[3(2-methyl-aziridinyl)-propionate], trimethylolpropane tris[2-aziridinyl butyrate], tris(1-aziridinyl)phosphine oxide, tris(2-methyl-laziridinyl)phosphine oxide, pentaerythritol tris-3-(1-aziridinyl propionate), pentaerythritol tetrakis-3-(1-aziridinyl propionate), and combinations thereof.

8. An isotropic polymerizable composition according to claim 1, wherein the acidic free-radically polymerizable monomer is selected from the group consisting of (meth)acrylic acid, maleic acid, monoalkyl esters of maleic acid, fumaric acid, monoalkyl esters of fumaric acid, itaconic acid, isocrotonic acid, crotonic acid, citraconic acid, and beta-carboxyethyl acrylate, 2-sulfoethyl methacrylate, styrene sulfonic acid, and 2-acrylamido-2-methylpropanesulfonic acid, vinyl phosphonic acid, and combinations thereof.

9. An isotropic polymerizable composition according to claim 1, wherein the oligomer having at least two pendant free-radically polymerizable groups is selected from the group consisting of aliphatic and aromatic urethane (meth)acrylate oligomers, polybutadiene (meth)acrylate oligomer, acrylic (meth)acrylate oligomers, polyether (meth)acrylate oligomers, aliphatic and aromatic polyester (meth)acrylate oligomers, epoxy (meth)acrylate oligomers, and combinations thereof.

10. A method of making a product comprising providing an isotropic polymerizable composition comprising a polyfunctional aziridine, an acidic free-radically polymerizable monomer, and an oligomer having at least two pendant free-radically polymerizable groups, wherein homopolymerization of the oligomer results in a polymer having a glass transition temperature of less than 50 degrees Celsius.

11. A method according to claim 10, wherein the isotropic polymerizable composition further comprises a curative.

12. A method according to claim 11, wherein the curative comprises a free-radical photoinitiator.

13. A method according to claim 11, wherein the curative comprises a free-radical thermal initiator.

14. A method according to claim 10, wherein based on the total weight of polyfunctional aziridine, acidic free-radically polymerizable monomer, and oligomer having at least two pendant free-radically polymerizable groups, the amount of polyfunctional aziridine is in a range of from 0.5 to 10 percent based on the total weight of weight polyfunctional aziridine, and wherein the amount of acidic free-radically polymerizable monomer is in a range of from 1 to 45 percent.

15. A method according to claim 10, wherein based on the total weight of polyfunctional aziridine, acidic free-radically polymerizable monomer, and oligomer having at least two pendant free-radically polymerizable groups, the amount of polyfunctional aziridine is in a range of from 2 to 4 percent based on the total weight of weight polyfunctional aziridine, and wherein the amount of acidic free-radically polymerizable monomer is in a range of from 2 to 20 percent.

16. A method according to claim 10, wherein the polyfunctional aziridine is selected from the group consisting of trimethylolpropane tris[3-aziridinyl propionate], trimethylolpropane tris[3-(2-methylaziridinyl)propionate], trimethylolpropane tris[2-aziridinylbutyrate], tris(1-aziridinyl)phosphine oxide, tris(2-methyl-1-aziridinyl)phosphine oxide, pentaerythritol tris[3-(1-aziridinyl)propionate], and pentaerythritol tetrakis[3-(1-aziridinyl)propionate], and combinations thereof.

17. A method according to claim 10, wherein the acidic free-radically polymerizable monomer is selected from the group consisting of (meth)acrylic acid, maleic acid, monoalkyl esters of maleic acid, fumaric acid, monoalkyl esters of fumaric acid, itaconic acid, isocrotonic acid, crotonic acid, citraconic acid, and beta-carboxyethyl acrylate, 2-sulfoethyl methacrylate, styrene sulfonic acid, and 2-acrylamido-2-methylpropanesulfonic acid, vinyl phosphonic acid, and combinations thereof.

18. A method according to claim 10, wherein the oligomer having at least two pendant free-radically polymerizable groups is selected from the group consisting of aliphatic and aromatic urethane (meth)acrylate oligomers, polybutadiene (meth)acrylate oligomer, acrylic (meth)acrylate oligomers, polyether (meth)acrylate oligomers, aliphatic and aromatic polyester (meth)acrylate oligomers, epoxy (meth)acrylate oligomers, and combinations thereof.

19. A product preparable by at least partially polymerizing an isotropic polymerizable composition comprising a polyfunctional aziridine, an acidic free-radically polymerizable monomer, and a polymer having at least two pendant free-radically polymerizable groups, wherein the oligomer has a glass transition temperature of less than 50 degrees Celsius.

20. A product according to claim 19, wherein the isotropic polymerizable composition further comprises a curative.

21. A product according to claim 20, wherein the curative comprises a free-radical photoinitiator.

22. A product according to claim 20, wherein the curative comprises a free-radical thermal initiator.

23. A product according to claim 19, wherein based on the total weight of polyfunctional aziridine, acidic free-radically polymerizable monomer, and oligomer having at least two pendant free-radically polymerizable groups, the amount of polyfunctional aziridine is in a range of from 0.5 to 10 percent based on the total weight of weight polyfunctional aziridine, and wherein the amount of acidic free-radically polymerizable monomer is in a range of from 1 to 45 percent.

24. A product according to claim 19, wherein based on the total weight of polyfunctional aziridine, acidic free-radically polymerizable monomer, and oligomer having at least two pendant free-radically polymerizable groups, the amount of polyfunctional aziridine is in a range of from 2 to 4 percent based on the total weight of weight polyfunctional aziridine, and wherein the amount of acidic free-radically polymerizable monomer is in a range of from 2 to 20 percent.

25. A product according to claim 19, wherein the polyfunctional aziridine is selected from the group consisting of trimethylolpropane tris[3-aziridinyl propionate], trimethylolpropane tris[3-(2-methylaziridinyl)propionate], trimethylolpropane tris[2-aziridinylbutyrate], tris(1-aziridinyl)phosphine oxide, tris(2-methyl-1-aziridinyl)phosphine oxide, pentaerythritol tris[3-(1-aziridinyl)propionate], and pentaerythritol tetrakis[3-(1-aziridinyl)propionate], and combinations thereof.

26. A product according to claim 19, wherein the acidic free-radically polymerizable monomer is selected from the group consisting of (meth)acrylic acid, maleic acid, monoalkyl esters of maleic acid, fumaric acid, monoalkyl esters of fumaric acid, itaconic acid, isocrotonic acid, crotonic acid, citraconic acid, and beta-carboxyethyl acrylate, 2-sulfoethyl methacrylate, styrene sulfonic acid, and 2-acrylamido-2-methylpropanesulfonic acid, vinyl phosphonic acid, and combinations thereof.

27. A product according to claim 19, wherein the oligomer having at least two pendant free-radically polymerizable groups is selected from the group consisting of aliphatic and aromatic urethane (meth)acrylate oligomers, polybutadiene (meth)acrylate oligomer, acrylic (meth)acrylate oligomers, polyether (meth)acrylate oligomers, aliphatic and aromatic polyester (meth)acrylate oligomers, epoxy (meth)acrylate oligomers, and combinations thereof.

28. A treated backing comprising a backing having a treatment secured thereto selected from the group consisting of a presize, a backsize, a subsize, and a saturant, wherein the treatment is preparable by at least partially polymerizing an isotropic polymerizable composition comprising a polyfunctional aziridine, an acidic free-radically polymerizable monomer, and an oligomer having at least two pendant free-radically polymerizable groups, and wherein homopolymerization of the oligomer results in a polymer having a glass transition temperature of less than 50 degrees Celsius.

29. A treated backing according to claim 28, wherein the isotropic polymerizable composition further comprises a curative.

30. A treated backing according to claim 29, wherein the curative comprises a free-radical photoinitiator.

31. A treated backing according to claim 29, wherein the curative comprises a free-radical thermal initiator.

32. A treated backing according to claim 28, wherein based on the total weight of polyfunctional aziridine, acidic free-radically polymerizable monomer, and oligomer having at least two pendant free-radically polymerizable groups, the amount of polyfunctional aziridine is in a range of from 0.5 to 10 percent based on the total weight of weight polyfunctional aziridine, and wherein the amount of acidic free-radically polymerizable monomer is in a range of from 1 to 45 percent.

33. A treated backing according to claim 28, wherein based on the total weight of polyfunctional aziridine, acidic free-radically polymerizable monomer, and oligomer having at least two pendant free-radically polymerizable groups, the amount of polyfunctional aziridine is in a range of from 2 to 4 percent based on the total weight of weight polyfunctional aziridine, and wherein the amount of acidic free-radically polymerizable monomer is in a range of from 2 to 20 percent.

34. A treated backing according to claim 28, wherein the polyfunctional aziridine is selected from the group consisting of trimethylolpropane tris[3-aziridinyl propionate], trimethylolpropane tris[3-(2-methylaziridinyl)propionate], trimethylolpropane tris[2-aziridinylbutyrate], tris(1-aziridinyl)phosphine oxide, tris(2-methyl-1-aziridinyl)phosphine oxide, pentaerythritol tris[3-(1-aziridinyl)propionate], and pentaerythritol tetrakis[3-(1-aziridinyl)propionate], and combinations thereof.

35. A treated backing according to claim 28, wherein the acidic free-radically polymerizable monomer is selected from the group consisting of (meth)acrylic acid, maleic acid, monoalkyl esters of maleic acid, fumaric acid, monoalkyl esters of fumaric acid, itaconic acid, isocrotonic acid, crotonic acid, citraconic acid, and beta-carboxyethyl acrylate, 2-sulfoethyl methacrylate, styrene sulfonic acid, and 2-acrylamido-2-methylpropanesulfonic acid, vinyl phosphonic acid, and combinations thereof.

36. A treated backing according to claim 28, wherein the oligomer having at least two pendant free-radically polymerizable groups is selected from the group consisting of aliphatic and aromatic urethane (meth)acrylate oligomers, polybutadiene (meth)acrylate oligomer, acrylic (meth)acrylate oligomers, polyether (meth)acrylate oligomers, aliphatic and aromatic polyester (meth)acrylate oligomers, epoxy (meth)acrylate oligomers, and combinations thereof.

37. A treated backing according to claim 28, wherein the backing comprises fabric.

38. A method of treating a backing comprising:
contacting at least a portion of a backing with an isotropic polymerizable composition comprising a polyfunctional aziridine, an acidic free-radically polymerizable monomer, and an oligomer having at least two pendant free-radically polymerizable groups, and wherein homopolymerization of the oligomer results in a polymer having a glass transition temperature of less than 50 degrees Celsius; and
at least partially polymerizing the isotropic polymerizable composition.

39. A method of treating a backing according to claim 38, wherein the isotropic polymerizable composition further comprises a curative.
